(19) United States
(12) Patent Application Publication
(10) Pub. No.: US 2019/0318264 A1
(43) Pub. Date: Oct. 17, 2019

(54) AUTOMATED THERMAL POLICY TUNING

(71) Applicants: Qiyong Brian Bian, Portland, OR (US); James Hermerding, San Jose, CA (US); Zhongsheng Wang, Portland, OR (US); Helin Cao, Portland, OR (US)

(72) Inventors: Qiyong Brian Bian, Portland, OR (US); James Hermerding, San Jose, CA (US); Zhongsheng Wang, Portland, OR (US); Helin Cao, Portland, OR (US)

(21) Appl. No.: 16/455,407

(22) Filed: Jun. 27, 2019

(51) Int. Cl. G06N 20/00

(52) U.S. Cl. CPC G06N 20/00

(57) ABSTRACT

Various systems and methods for implementing automatic thermal policy tuning are described herein. A system for thermal policy tuning on an electronic device, comprising: a memory device configured to store instructions; and a processor subsystem, which when configured by the instructions, is operable to perform the operations comprising: accessing a thermal policy configuration comprising a plurality of parameters to control a thermal policy of the electronic device; using the thermal policy configuration as input to a machine-learning algorithm, the machine-learning algorithm using an objective function to determine a revised thermal policy configuration; and implementing the revised thermal policy configuration on the electronic device.

### TECHNICAL FIELD

Embodiments described herein generally relate to computing devices, and in particular, to automated thermal policy tuning.

### BACKGROUND

During operation, the electricity used in a computing device generates heat that may reduce the performance of components in the device and may shorten its lifespan. Conventional techniques to reduce the operating temperature include the use of fans, heatsinks, vents, and water cooling. Some electronic components may throttle down speeds to produce less heat. However, such throttling also reduces performance.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating a process for deriving a thermal policy, according to an embodiment;

FIG. 2 is an illustration of a sample thermal policy, according to an embodiment;

FIG. 3 is diagram illustrating a process for deriving a thermal policy, according to an embodiment;

FIG. 4 is an example of temperature and score input data for Equation 1, according to an embodiment;

FIG. 5 is a graph illustrating a comparison between a manually configured thermal policy and an auto-tuned thermal policy, according to an embodiment;

FIG. 6 is a flowchart illustrating a method of thermal policy tuning on an electronic device, according to an embodiment; and

FIG. 7 is a block diagram illustrating an example machine upon which any one or more of the techniques (e.g., methodologies) discussed herein may perform, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Heat generated while operating an electronic device may cause premature failure, poor performance, or malfunctions. Additionally, excess heat may cause user discomfort while handling or using the device due to a high skin temperature (e.g., the surface temperature of a tablet back cover). Components of a computing device, such as a processor, controller, memory, or the like, may have active or passive cooling devices associated to them. Active cooling devices include fans, water cooling systems, and the like. Passive cooling devices include heatsinks and vents. Passive cooling may also include mechanisms such as reducing the electronic device's performance state. For example, a processor may be “clocked down” by reducing its operating frequency to a lower value, thereby reducing the heat generated.

Electronic components have a prescribed safe operating temperature range. When operating above the temperature range, the electronic component may act erratically. Additionally, high operating temperatures may cause high skin or surface temperatures of enclosures, cases, covers, or the like, which may impact user experience. In order to address thermal conditions, the electronic device may have one or more thermal policies.

The thermal policies are rules that are used to control various cooling devices or control the operation of the electronic device to effect passive cooling. Designing thermal policies is a difficult task. If the policies are too restrictive, then the electronic device may underperform. If the policies are too permissive, then the electronic device may experience a dangerous operating environment. For instance, if the policy step down processor speeds too aggressively in response to rising temperatures, then the performance may be hindered beyond what is needed. On the other hand, if the processor speed is not stepped down before a critical operating temperature, the processor may fail or behave erratically or cause discomfort to users.

In conventional systems, system performance is highly sensitive to the quality of the thermal policy. It is important to generate an optimal thermal policy when shipping product. This is often performed using a configuration tuning process. However, the tuning process is largely manually performed resulting in a complex and labor-intensive endeavor. As a result, it is difficult to produce units timely with efficiency and consistent results. This difficulty is multiplied when considered over several related product lines (e.g., several processor stock keeping units (SKUs)) and across several original equipment manufacturers (OEMs) that integrate each SKU into a final computer platform. In some cases, poor performance experienced by the end user is not a result of a hardware, but instead because of unoptimized thermal policies. What is needed is an automated process to optimize the thermal policy to balance device performance with safe operation. Such a process provides advantages of more consistent performance, fewer hardware failures, lower labor costs, auditability, fewer user complaints, and other features.

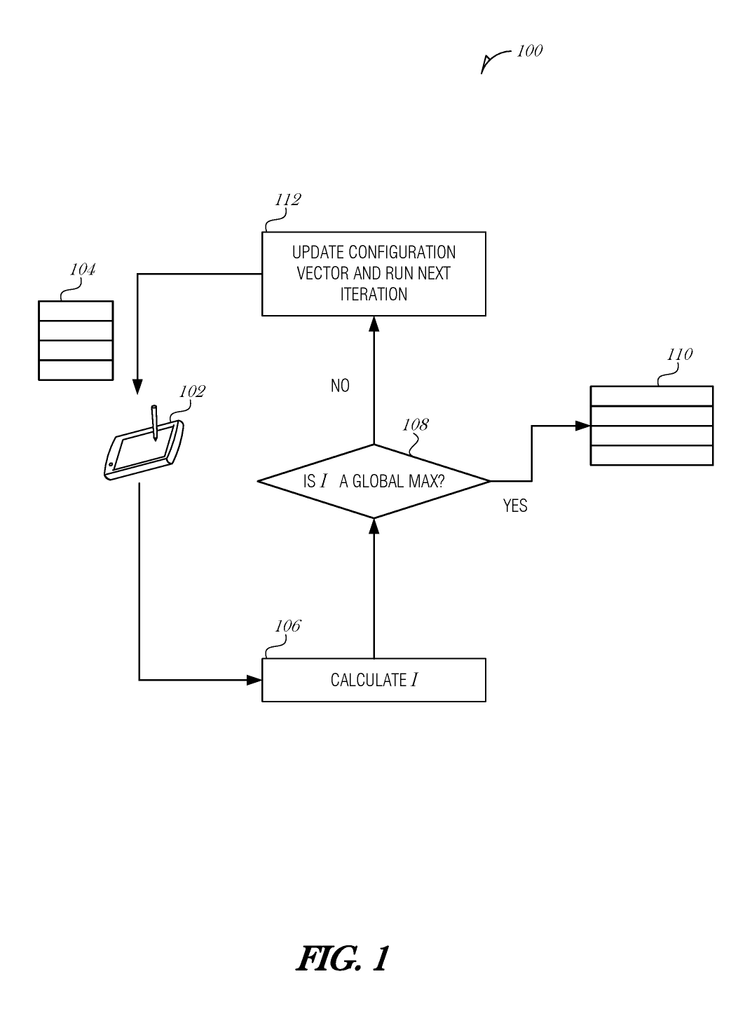

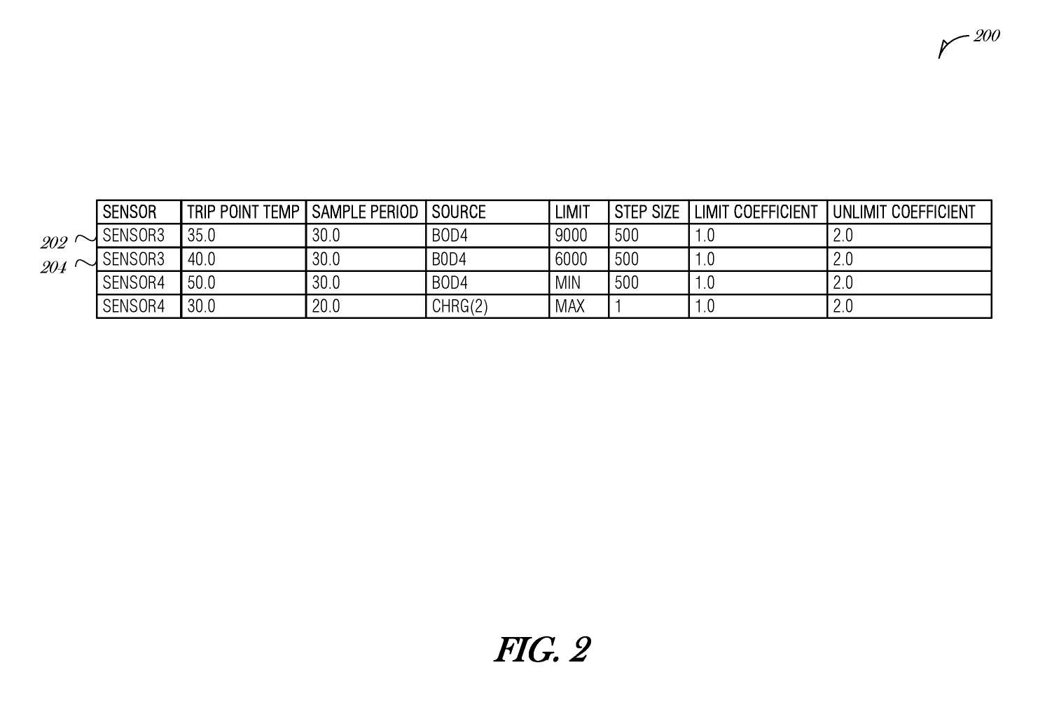

FIG. 1 is a diagram illustrating a process 100 for deriving a thermal policy, according to an embodiment. The process 100 of FIG. 1 is performed during manufacturing or design in order to tun a platform before high-volume shipping. A device under test (DUT) 102 is operating using a test suite. The DUT may be operating using a test suite with pre-arranged tests to commit the DUT to approximately the same performance loads on each iteration of the test suite. The testing may be performed on each shippable unit or may be performed on a per-SKU level. In general, the DUT 102 is observed while under test. The DUT uses a current thermal policy 104. The thermal policy 104 includes trip points, priority information, sample periods, step sizes, and other parameters for use in a thermal management system. FIG. 2 is an illustration of a sample thermal policy 200, according to an embodiment.

The thermal policy 200 illustrated in FIG. 2 is for active and passive cooling. Passive cooling may be achieved in several ways such as by clocking down a processor, offlining a processor core, reducing charging rate, reducing communication device polling time, lowering communication device power or transmit/receive rates, reducing I/O device throughput, or the like. Other policies may include different parameters to control operation of an electronic device and effect passive cooling. For instance, parameters to reduce or suspend charging rate, control power to an antenna or communication circuitry, parameters to reduce connection polling time, or the like may be implemented in a policy. Active cooling in contrast is cooling using a fan or other mechanism to reduce the surface temperature of the electronic component.

The thermal policy 200 may include policies for both active and passive cooling, policies for only active cooling, or policies for only passive cooling. The example thermal policy 200 illustrated in FIG. 2 only contains parameters for passive cooling through reducing supplied power, however, it is understood that parameters for other types of passive cooling or active cooling may be included in other thermal policies. Parameters for active cooling may include fan speed, step sizes for fan speed, limit and unlimit coefficients, number of active fans, and the like.

In the thermal policy 200, each row is a rule. A rule is initiated based on a triggering event. The triggering event may be raised by a hardware exception, when a trip point temperature is encountered, by software detecting lower performance (e.g., device driver or monitoring software detecting condition), or the like. In some instances, the rule is evaluated after a sample period, which may be provided in the rule. Other information about the resulting action is included in the rule. It is understood that the thermal policy 200 is not limiting, and that other configuration parameters may be present or omitted from thermal policies.

As an example, as illustrated in the first line is a rule 202, when the temperature of the component exceeds 35.0° C., power is decreased by 500 mW (Step Size*Limit Coefficient) from a current power consumption. This rule 202 is has a maximum power consumption of 9000 mW (Limit). Thus, if the component was drawing 12500 mW of power, then the power is reduced in 500 mW steps until the 9000 mW limit. If the temperature continues to increase and crosses over the 40.0° C. threshold, then the second rule 204 is invoked and the power is adjusted to a maximum limit of 6000 mW using 500 mW steps.

Lowering the power consumption may lower the amount of heat generated, and consequently may lower the temperature of the component. Thus, in a later sampling period the first rule 202 may again be invoked and the power consumption may be allowed to increase. When increasing power, the step size may be different than when decreasing power. Based on rule 202, the Unlimit Coefficient of 2.0 is used resulting in a 1000 mW step size (500 mW*2.0). As such, when the temperature is under a threshold, the component is provided increased power faster than when stepping down. If the temperature exceeds the threshold of a rule (e.g., rule 202 or rule 204), then the power is reduced according to the step size and the limit coefficient. This oscillation may reduce the overall performance of the component when compared to performance under a less restrictive thermal policy.

Returning to FIG. 1, metrics such as the temperature of various components, processor cycles, performance test times, compiled scores, and the like may be used in an evaluation function 106 to compute I. The value I is a scalar indicator of how well a current thermal policy being used by the DUT 102 is performing.

In an embodiment, the function used to calculate the scalar indicator takes the form of:

I=ƒ(tₙ,Tₙ,sₙ)=S(tₙ,sₙ)−κ*TO(tₙ,Tₙ)−γ*SAT(tₙ,Tₙ)κ,γ≥0 Eq. 1

where tₙ is time, Tₙ is skin temperature, and sₙ is benchmark score. S(tₙ, sₙ) calculates a statistic result of benchmark scores over time or at a time. This may be a sigma, sum, min, average, or some other calculation for multiple benchmark scores. S(tₙ, sₙ) may be a weighted function. For example, a benchmark test may be performed successively, resulting in several benchmark results at varying operating temperatures. The benchmark results may be averaged. Alternatively, the benchmark results may be weighted based on the time such that benchmarks scores obtained when the system was up for less time (and running at lower temperatures) are weighted less than scores obtained when the system was up for longer (and running at higher temperatures). The longer uptime may represent a more accurate benchmark score because of the steady temperature state.

The first penalty term is derived from temperature overshooting beyond the OEM's skip temperature limit Tₗᵢₘᵢₜ, which may be obtained from OEM specifications. Temperature overshooting (TO) is calculated by:

TO(tₙ,Tₙ)=∫ₜ_{₀}^{t′} max(0,T−Tₗᵢₘᵢₜ)dt Eq. 2

The second penalty term, SAT(tₙ, Tₙ), is derived from temperature fluctuation after saturation. Saturation is when the temperature achieves a relative steady state with minimal fluctuation (e.g., the temperature stays within an oscillation range around the steady state temperature for a period of time). The penalty term SAT(tₙ, Tₙ) may be obtained from various methods such as maximum, average, or summed amplitude of oscillations, standard deviation, etc.

In Eq. 1, the κ and γ terms are used as customization variables to fit OEM design requirements (e.g., weighting constants). As a result, the scalar indicator I is the benchmark score reduced by the penalty terms for temperature overshooting and amount of temperature fluctuation after reaching temperature saturation.

For each thermal policy configuration, the temperature and score traces are manipulated differently leading to different scalar indicator values. The thermal policy configuration may be transformed to a configuration vector \vec{C}, and a mapping function g is used to map \vec{C} to I.

g(\vec{C})=I Eq. 3

Thus, the process of finding an optimized \vec{C} may be simplified as optimizing g(\vec{C}) or I.

Returning to the discussion of FIG. 1, at decision 108, it is determined whether the current I is a global maximum. If it is, then the current thermal policy 104 is stored as the optimal thermal policy 110. This optimal thermal policy 110 may then be used as the default thermal policy for shipped units, for example. If the current I is not a global maximum, then the thermal policy is reconfigured (operation 112) and the DUT 102 is tested again.

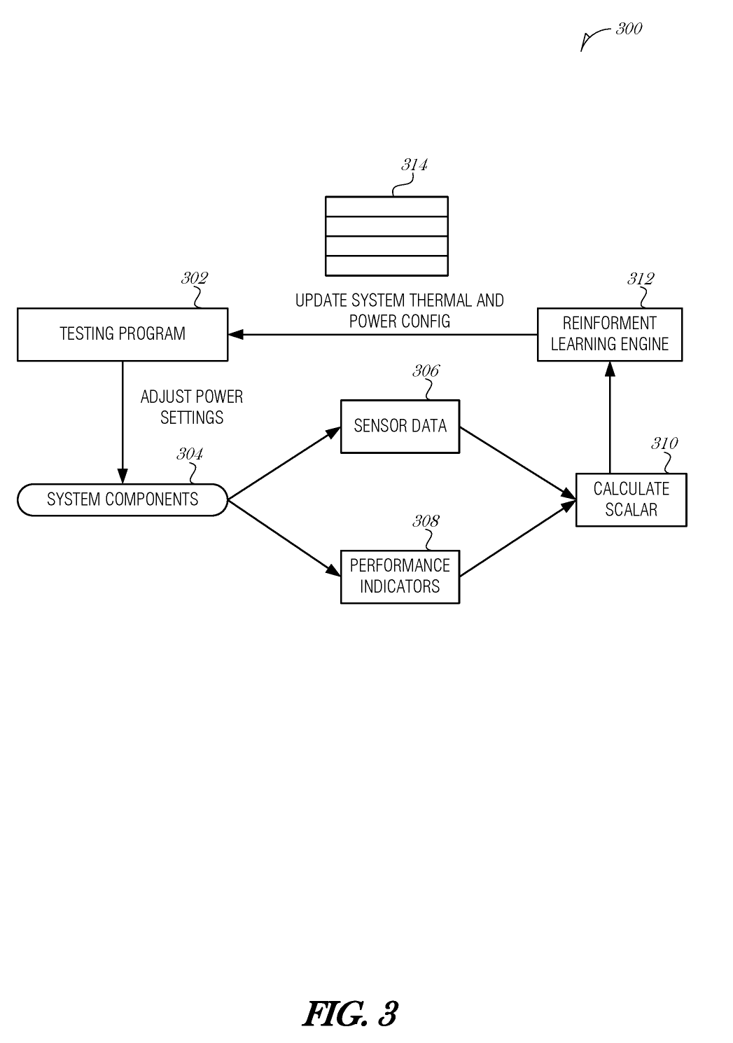

FIG. 3 is diagram illustrating a process 300 for deriving a thermal policy, according to an embodiment. The process 300 may be performed after production, for example, by an OEM or by an end user. The test program 302 is used to manage power settings of various system components 304 of a DUT. The power settings may include the thermal policy configuration. The system components 304 may include a central processing unit (CPU), a graphics processing units (GPU), a radio or communication unit (WiFi, cellular, GPS, Bluetooth, etc.), an application specific integrated circuit (ASIC), a field-programmable gate array (FPGA), a digital signal processor (DSP), a memory module (DRAM), or other microcontrollers or microprocessors.

Sensor data (306) and performance indicators (308) are collected. The sensor data 306 may include various metrics such as temperature, power consumption, fan speed, or the like. The performance indicators 308 may include a current clock speed, execution time, memory access metrics, benchmark scores, or the like. At operation 310, the sensor data 306 and performance indicators 308 are used to calculate I using an evaluation function (e.g., using Eq. 1). The I value is used in a reinforcement learning engine 312 to compare the current thermal policy with previous thermal policies and derive a revised thermal policy 314. The revised thermal policy is installed into the platform by the test program 302. The monitoring process 300 may be periodically reevaluated or may be reevaluated when initiated by a user to further tune performance of the DUT.

The reinforcement learning engine 312 may independently learn to adjust thermal power settings according to the user behavior over time. The evaluation function may be adjusted by a user to adjust the parameters of the evaluation to their own needs.

The reinforcement learning engine 312 may be implemented with a machine-learning optimization algorithm. Each column in the thermal policy 314 may be used as a controllable parameter (e.g., dimension). The policies may be optimized by solving a n-dimensional optimization problem. Over time, performance statistics may be input into the reinforcement learning engine 312 to train the process. The reinforcement learning engine 312 may run on real-time data streaming from a benchmark test, which may operate in the background, for example, while a computer is in operation.

There are three main components in a machine-learning-based production optimization: 1) selection of the objective function, 2) multi-dimensional optimization, and 3) actionable output. The objective function may be any formula that predicts production rate or production output given settings for all controllable variables. The objective function may be any formula that predicts production rate or production output given settings for all controllable variables. Often times these functions cannot be expressed in mathematical forms and are stochastic in nature, and their outputs may only be observed over time by adding an additional time variable, as the one illustrated in Equation 1.

The multi-dimensional optimization algorithm may be any optimization algorithm that uses the prediction algorithm and searches for controllable variables that maximize production. In an embodiment, the multi-dimensional optimization algorithm may be a stochastic basin hopping algorithm. In an embodiment, the multi-dimensional optimization algorithm may be a Bayesian Optimization with Gaussian Process.

The actionable output includes recommendations on settings of the control variables. The actionable output may also include some indicia of potential improvement of the production output. Here, the actionable output may be a reconfigured policy. It is understood that any evaluation function or optimization algorithm may be used depending on system design and requirements.

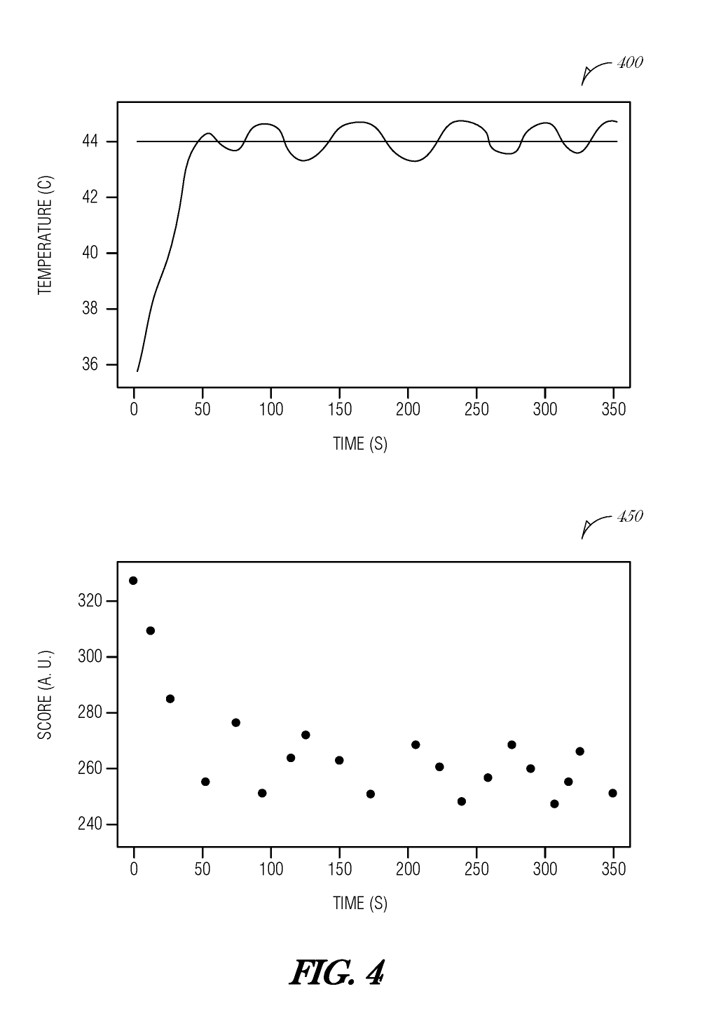

FIG. 4 is an example of temperature and score input data for Equation 1, according to an embodiment. In temperature trace 400, temperature data is captured over time. A temperature threshold Tₗᵢₘᵢₜ of 44° C. is illustrated. As may be observed, when the temperature threshold is exceeded, throttling, fans, or other cooling mechanisms are implemented to reduce the temperature under the threshold Tₗᵢₘᵢₜ. Oscillating and overshooting behaviors are evident in the temperature trace 400.

A score trace 450 shows the scores over time. The score trace 450 is synchronized with the temperature trace 400. The scores in the score trace 450 are arbitrary units and may be based on any type of benchmark, for example. The benchmark test used may depend on the type of component this is under test. For instance, if the component is a processor, then the benchmark test may test integer math, compression, prime number test, encryption, floating point math, sorting, single thread testing, physics testing, memory I/O, and the like. The score may represent a combination of several tests (e.g., an average over the tests used).

In the first portion of the traces 400, 450, the score is the highest. As the temperature rises, the performance decreases. When the temperature exceeds the threshold temperature, there is a corresponding dip in performance.

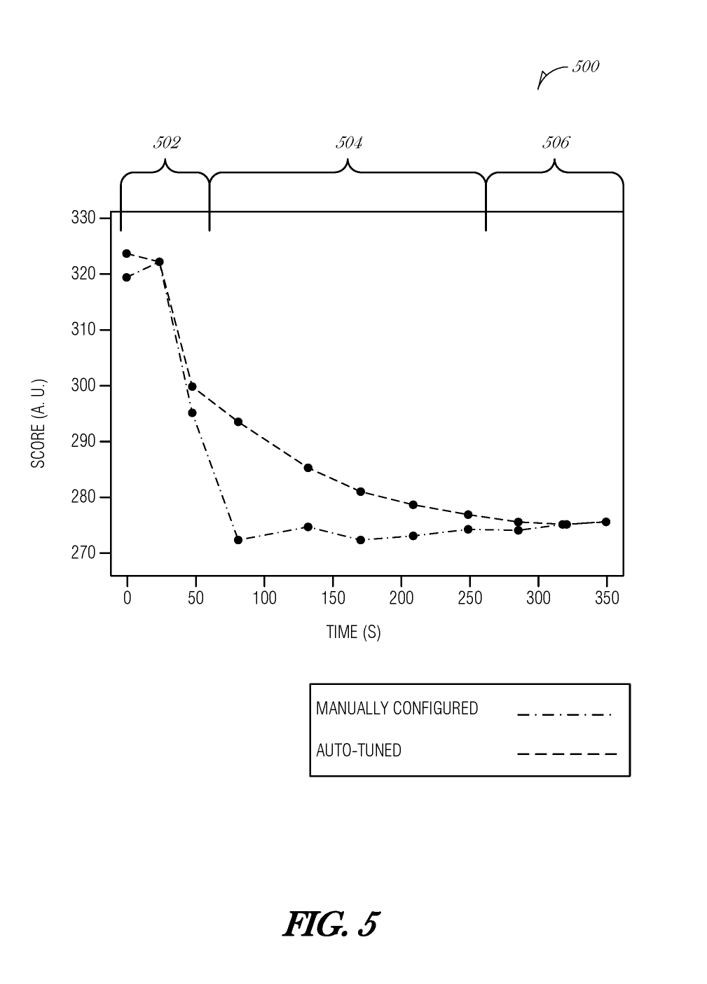

FIG. 5 is a graph 500 illustrating a comparison between a manually configured thermal policy and an auto-tuned thermal policy, according to an embodiment. The graph 500 shows performance scores over time. In the first section 502, the performance score is relatively similar between the manually-configured policy and the auto-tuned policy. However, in the second section 504, the manually-configured policy is overaggressive and throttles the device operation (as shown by the lower performance score). In the third section 506, the DUT reaches a steady state and the performance equilibrates. The auto-tuned policy outperforms the manual one by a very large margin: approximately 4% end-to-end system level improvement. Furthermore, from a performance throttling perspective, the auto-tuned policy gives a much smoother transition compared with the manual one.

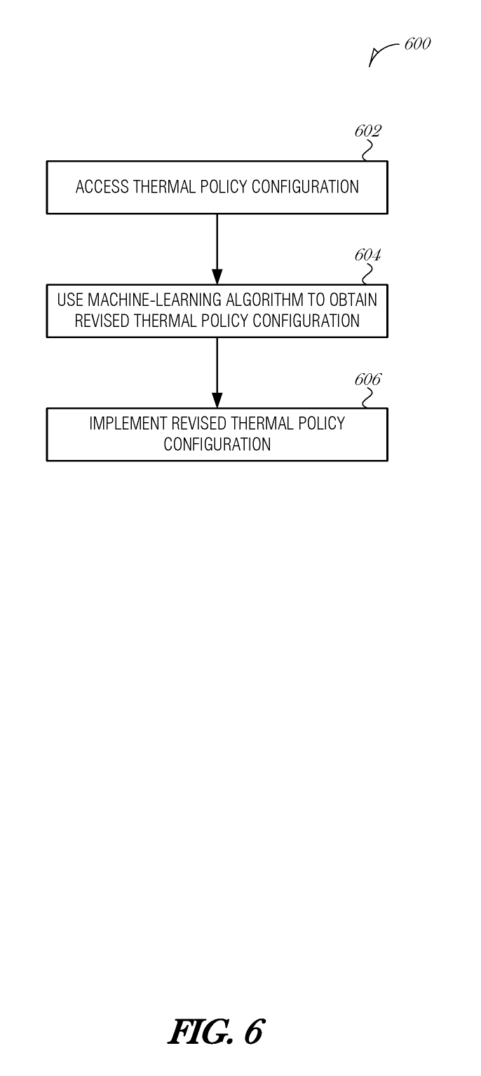

FIG. 6 is a flowchart illustrating a method 600 of thermal policy tuning on an electronic device, according to an embodiment. At 602, a thermal policy configuration comprising a plurality of parameters to control a thermal policy of the electronic device is accessed.

At 604, the thermal policy configuration is used as input to a machine-learning algorithm, the machine-learning algorithm using an objective function to determine a revised thermal policy configuration.

At 606, the revised thermal policy configuration is implemented on the electronic device.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

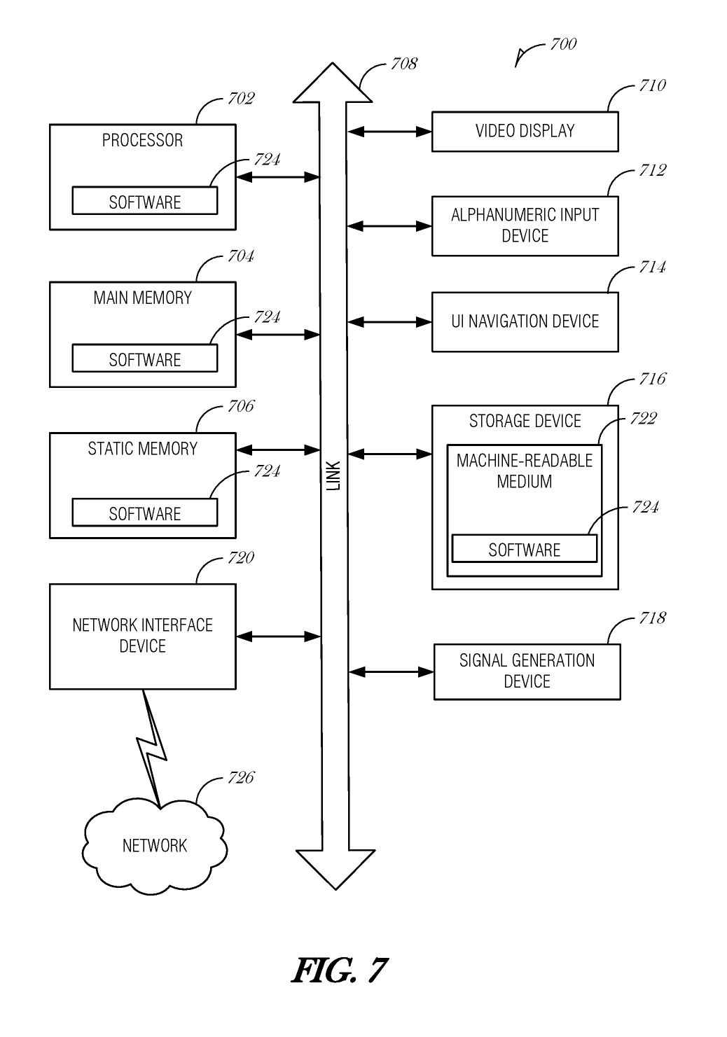

FIG. 7 is a block diagram illustrating a machine in the example form of a computer system 700, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system for thermal policy tuning on an electronic device, comprising: a memory device configured to store instructions; and a processor subsystem, which when configured by the instructions, is operable to perform the operations comprising: accessing a thermal policy configuration comprising a plurality of parameters to control a thermal policy of the electronic device; using the thermal policy configuration as input to a machine-learning algorithm, the machine-learning algorithm using an objective function to determine a revised thermal policy configuration; and implementing the revised thermal policy configuration on the electronic device.

In Example 2, the subject matter of Example 1 includes, wherein the electronic device comprises a processor.

In Example 3, the subject matter of Examples 1-2 includes, wherein the electronic device comprises a graphics processing unit.

In Example 4, the subject matter of Examples 1-3 includes, wherein the electronic device comprises a system on a chip.

In Example 5, the subject matter of Examples 1-4 includes, wherein the plurality of parameters comprise a trip point temperature, a sample period, a limit, and a step size.

In Example 6, the subject matter of Examples 1-5 includes, wherein the plurality of parameters comprise a limit coefficient and an unlimit coefficient.

In Example 7, the subject matter of Examples 1-6 includes, wherein the machine-learning algorithm comprises a Bayesian Optimization with Gaussian Process.

In Example 8, the subject matter of Examples 1-7 includes, monitoring the electronic device to obtain performance indicators of the electronic device while operating under the revised thermal policy configuration.

In Example 9, the subject matter of Example 8 includes, wherein the performance indicators are obtained from a benchmark test used to evaluate the electronic device.

In Example 10, the subject matter of Examples 8-9 includes, wherein the performance indicators are used as constraints of the objective function.

In Example 11, the subject matter of Examples 1-10 includes, wherein the objective function comprises a scoring term, a temperature overshooting penalty term, and a saturation penalty term.

In Example 12, the subject matter of Example 11 includes, wherein the scoring term represents a statistic result of benchmark scores of the electronic device.

In Example 13, the subject matter of Examples 11-12 includes, wherein the temperature overshooting penalty term represents an amount that the electronic device is over a threshold temperature over a period of time.

In Example 14, the subject matter of Examples 11-13 includes, wherein the saturation penalty term represents an amount of temperature fluctuation after the electronic device reaches temperature saturation.

Example 15 is a method for thermal policy tuning on an electronic device, comprising: accessing a thermal policy configuration comprising a plurality of parameters to control a thermal policy of the electronic device; using the thermal policy configuration as input to a machine-learning algorithm, the machine-learning algorithm using an objective function to determine a revised thermal policy configuration; and implementing the revised thermal policy configuration on the electronic device.

In Example 16, the subject matter of Example 15 includes, wherein the electronic device comprises a processor.

In Example 17, the subject matter of Examples 15-16 includes, wherein the electronic device comprises a graphics processing unit.

In Example 18, the subject matter of Examples 15-17 includes, wherein the electronic device comprises a system on a chip.

In Example 19, the subject matter of Examples 15-18 includes, wherein the plurality of parameters comprise a trip point temperature, a sample period, a limit, and a step size.

In Example 20, the subject matter of Examples 15-19 includes, wherein the plurality of parameters comprise a limit coefficient and an unlimit coefficient.

In Example 21, the subject matter of Examples 15-20 includes, wherein the machine-learning algorithm comprises a Bayesian Optimization with Gaussian Process.

In Example 22, the subject matter of Examples 15-21 includes, monitoring the electronic device to obtain performance indicators of the electronic device while operating under the revised thermal policy configuration.

In Example 23, the subject matter of Example 22 includes, wherein the performance indicators are obtained from a benchmark test used to evaluate the electronic device.

In Example 24, the subject matter of Examples 22-23 includes, wherein the performance indicators are used as constraints of the objective function.

In Example 25, the subject matter of Examples 15-24 includes, wherein the objective function comprises a scoring term, a temperature overshooting penalty term, and a saturation penalty term.

In Example 26, the subject matter of Example 25 includes, wherein the scoring term represents a statistic result of benchmark scores of the electronic device.

In Example 27, the subject matter of Examples 25-26 includes, wherein the temperature overshooting penalty term represents an amount that the electronic device is over a threshold temperature over a period of time.

In Example 28, the subject matter of Examples 25-27 includes, wherein the saturation penalty term represents an amount of temperature fluctuation after the electronic device reaches temperature saturation.

Example 29 is at least one machine-readable medium including instructions, which when executed by a machine, cause the machine to perform operations of any of the methods of Examples 15-28.

Example 30 is an apparatus comprising means for performing any of the methods of Examples 15-28.

Example 31 is an apparatus for thermal policy tuning on an electronic device, comprising: means for accessing a thermal policy configuration comprising a plurality of parameters to control a thermal policy of the electronic device; means for using the thermal policy configuration as input to a machine-learning algorithm, the machine-learning algorithm using an objective function to determine a revised thermal policy configuration; and means for implementing the revised thermal policy configuration on the electronic device.

In Example 32, the subject matter of Example 31 includes, wherein the electronic device comprises a processor.

In Example 33, the subject matter of Examples 31-32 includes, wherein the electronic device comprises a graphics processing unit.

In Example 34, the subject matter of Examples 31-33 includes, wherein the electronic device comprises a system on a chip.

In Example 35, the subject matter of Examples 31-34 includes, wherein the plurality of parameters comprise a trip point temperature, a sample period, a limit, and a step size.

In Example 36, the subject matter of Examples 31-35 includes, wherein the plurality of parameters comprise a limit coefficient and an unlimit coefficient.

In Example 37, the subject matter of Examples 31-36 includes, wherein the machine-learning algorithm comprises a Bayesian Optimization with Gaussian Process.

In Example 38, the subject matter of Examples 31-37 includes, means for monitoring the electronic device to obtain performance indicators of the electronic device while operating under the revised thermal policy configuration.

In Example 39, the subject matter of Example 38 includes, wherein the performance indicators are obtained from a benchmark test used to evaluate the electronic device.

In Example 40, the subject matter of Examples 38-39 includes, wherein the performance indicators are used as constraints of the objective function.

In Example 41, the subject matter of Examples 31-40 includes, wherein the objective function comprises a scoring term, a temperature overshooting penalty term, and a saturation penalty term.

In Example 42, the subject matter of Example 41 includes, wherein the scoring term represents a statistic result of benchmark scores of the electronic device.

In Example 43, the subject matter of Examples 41-42 includes, wherein the temperature overshooting penalty term represents an amount that the electronic device is over a threshold temperature over a period of time.

In Example 44, the subject matter of Examples 41-43 includes, wherein the saturation penalty term represents an amount of temperature fluctuation after the electronic device reaches temperature saturation.

Example 45 is at least one machine-readable medium including instructions for thermal policy tuning on an electronic device, which when executed by a machine, cause the machine to perform operations comprising: accessing a thermal policy configuration comprising a plurality of parameters to control a thermal policy of the electronic device; using the thermal policy configuration as input to a machine-learning algorithm, the machine-learning algorithm using an objective function to determine a revised thermal policy configuration; and implementing the revised thermal policy configuration on the electronic device.

In Example 46, the subject matter of Example 45 includes, wherein the electronic device comprises a processor.

In Example 47, the subject matter of Examples 45-46 includes, wherein the electronic device comprises a graphics processing unit.

In Example 48, the subject matter of Examples 45-47 includes, wherein the electronic device comprises a system on a chip.

In Example 49, the subject matter of Examples 45-48 includes, wherein the plurality of parameters comprise a trip point temperature, a sample period, a limit, and a step size.

In Example 50, the subject matter of Examples 45-49 includes, wherein the plurality of parameters comprise a limit coefficient and an unlimit coefficient.

In Example 51, the subject matter of Examples 45-50 includes, wherein the machine-learning algorithm comprises a Bayesian Optimization with Gaussian Process.

In Example 52, the subject matter of Examples 45-51 includes, monitoring the electronic device to obtain performance indicators of the electronic device while operating under the revised thermal policy configuration.

In Example 53, the subject matter of Example 52 includes, wherein the performance indicators are obtained from a benchmark test used to evaluate the electronic device.

In Example 54, the subject matter of Examples 52-53 includes, wherein the performance indicators are used as constraints of the objective function.

In Example 55, the subject matter of Examples 45-54 includes, wherein the objective function comprises a scoring term, a temperature overshooting penalty term, and a saturation penalty term.

In Example 56, the subject matter of Example 55 includes, wherein the scoring term represents a statistic result of benchmark scores of the electronic device.

In Example 57, the subject matter of Examples 55-56 includes, wherein the temperature overshooting penalty term represents an amount that the electronic device is over a threshold temperature over a period of time.

In Example 58, the subject matter of Examples 55-57 includes, wherein the saturation penalty term represents an amount of temperature fluctuation after the electronic device reaches temperature saturation.

Example 59 is at least one machine-readable medium including instructions that, when executed by processing circuitry, cause the processing circuitry to perform operations to implement of any of Examples 1-58.

Example 60 is an apparatus comprising means to implement of any of Examples 1-58.

Example 61 is a system to implement of any of Examples 1-58.

Example 62 is a method to implement of any of Examples 1-58.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for thermal policy tuning on an electronic device, comprising:
a memory device configured to store instructions; and
a processor subsystem, which when configured by the instructions, is operable to perform the operations comprising:
accessing a thermal policy configuration comprising a plurality of parameters to control a thermal policy of the electronic device;
using the thermal policy configuration as input to a machine-learning algorithm, the machine-learning algorithm using an objective function to determine a revised thermal policy configuration; and
implementing the revised thermal policy configuration on the electronic device.

2. The system of claim 1, wherein the electronic device comprises a processor.

3. The system of claim 1, wherein the electronic device comprises a graphics processing unit.

4. The system of claim 1, wherein the electronic device comprises a system on a chip.

5. The system of claim 1, wherein the plurality of parameters comprise a trip point temperature, a sample period, a limit, and a step size.

6. The system of claim 1, wherein the plurality of parameters comprise a limit coefficient and an unlimit coefficient.

7. The system of claim 1, wherein the machine-learning algorithm comprises a Bayesian Optimization with Gaussian Process.

8. The system of claim 1, comprising monitoring the electronic device to obtain performance indicators of the electronic device while operating under the revised thermal policy configuration.

9. The system of claim 8, wherein the performance indicators are obtained from a benchmark test used to evaluate the electronic device.

10. The system of claim 8, wherein the performance indicators are used as constraints of the objective function.

11. The system of claim 1, wherein the objective function comprises a scoring term, a temperature overshooting penalty term, and a saturation penalty term.

12. The system of claim 11, wherein the scoring term represents a statistic result of benchmark scores of the electronic device.

13. The system of claim 11, wherein the temperature overshooting penalty term represents an amount that the electronic device is over a threshold temperature over a period of time.

14. The system of claim 11, wherein the saturation penalty term represents an amount of temperature fluctuation after the electronic device reaches temperature saturation.

15. A method for thermal policy tuning on an electronic device, comprising:
accessing a thermal policy configuration comprising a plurality of parameters to control a thermal policy of the electronic device;
using the thermal policy configuration as input to a machine-learning algorithm, the machine-learning algorithm using an objective function to determine a revised thermal policy configuration; and
implementing the revised thermal policy configuration on the electronic device.

16. The method of claim 15, wherein the machine-learning algorithm comprises a Bayesian Optimization with Gaussian Process.

17. The method of claim 15, comprising monitoring the electronic device to obtain performance indicators of the electronic device while operating under the revised thermal policy configuration.

18. The method of claim 17, wherein the performance indicators are obtained from a benchmark test used to evaluate the electronic device.

19. The method of claim 17, wherein the performance indicators are used as constraints of the objective function.

20. At least one machine-readable medium including instructions for thermal policy tuning on an electronic device, which when executed by a machine, cause the machine to perform operations comprising:
accessing a thermal policy configuration comprising a plurality of parameters to control a thermal policy of the electronic device;
using the thermal policy configuration as input to a machine-learning algorithm, the machine-learning algorithm using an objective function to determine a revised thermal policy configuration; and
implementing the revised thermal policy configuration on the electronic device.

21. The machine-readable medium of claim 20, wherein the objective function comprises a scoring term, a temperature overshooting penalty term, and a saturation penalty term.

22. The machine-readable medium of claim 21, wherein the scoring term represents a statistic result of benchmark scores of the electronic device.

23. The machine-readable medium of claim 21, wherein the temperature overshooting penalty term represents an amount that the electronic device is over a threshold temperature over a period of time.

24. The machine-readable medium of claim 21, wherein the saturation penalty term represents an amount of temperature fluctuation after the electronic device reaches temperature saturation.
